(19) United States
(12) Patent Application Publication
(10) Pub. No.: US 2024/0300330 A1
(43) Pub. Date: Sep. 12, 2024

(54) DEVICE AND A METHOD FOR COVERING OR SWITCHING OFF INFORMATION DISPLAYED ON AN OUTER SURFACE OF A VEHICLE

(71) Applicant: DAIMLER TRUCK AG, Leinfelden-Echterdingen (DE)

(72) Inventors: Fridtjof STEIN, Leinfelden-Echterdingen (DE); Jonas TORZEWSKI, Leinfelden-Echterdingen (DE); Dietmar ZECHMANN, Leinfelden-Echterdingen (DE); Johannes PLAUM, Leinfelden-Echterdingen (DE)

(21) Appl. No.: 18/597,202

(22) Filed: Mar. 6, 2024

(30) Foreign Application Priority Data
Mar. 7, 2023 (DE) 10 2023 105 644.1

(51) Int. Cl. B60K 35/22; G09F 21/04

(52) U.S. Cl. CPC B60K 35/22; G09F 21/048

(57) ABSTRACT

A device and a method for covering or switching off information displayed on an outer surface of a vehicle involves the device covering or switching off information displayed on the outer surface when a situation deviating from a normal state is present.

### CROSS-REFERENCE TO RELATED APPLICATIONS

This application claims priority under 35 U.S.C. § 119 to German patent application DE 10 2023 105 644.1, filed on Mar. 7, 2023, the entire content of which is herein expressly incorporated by reference.

### BACKGROUND AND SUMMARY OF THE INVENTION

Exemplary embodiments of the invention relate to a device for covering or switching off information displayed on an outer surface of a vehicle, as well as to a method for covering or switching off information displayed on an outer surface of a vehicle.

Operators of utility vehicles, for example haulage contractors, and their clients often attach adverts and company logos to a trailer, semi-trailer, or container of the utility vehicle in order to present themselves from an advertising perspective.

DE 198 51 720 A1 describes a fuel tanker provided on at least one side wall with at least one outer advertising surface formed from at least two segments comprising advertising media, the segments being able to be mechanically adjusted between a position in which they form the visible advertising surface and a position in which they are not visible as an advertising surface.

Exemplary embodiments of the invention are directed to a novel device and a novel method for covering or switching off information displayed on an outer surface of a vehicle.

A device for covering or switching off information displayed on an outer surface of a vehicle is proposed. According to the invention, the device is configured to cover or switch off the information displayed on the outer surface if there is a situation deviating from a normal state present.

A membrane arranged over the outer surface provided with the information is provided in an embodiment, the membrane being transparent in the normal state and being configured to become untransparent by applying a voltage.

In one embodiment, the membrane is configured to gradually become untransparent by applying a voltage.

In one embodiment, the device has an electronic display unit, on which the information can be depicted, wherein the device is configured to hide the depiction of the information on the display unit or to switch off the display unit if there is a situation deviating from the normal state present.

In one embodiment, the device has a roller blind, wherein the device is configured to pull the roller blind over the outer surface with the information if there is a situation deviating from the normal state present.

In one embodiment, the information displayed on the outer surface is formed as a brand logo, wherein the device is configured to fold down the brand logo in a situation deviating from the normal state and to make its rear side with a neutral surface visible. This embodiment is suitable for a brand logo applied to a cab of the vehicle, for example.

According to one aspect of the present invention, a method for operating a device for covering or switching off information displayed on an outer surface of a vehicle is proposed, wherein, upon recognizing a situation of the vehicle deviating from a normal state, the information displayed on the outer surface is covered or switched off.

In one embodiment, the surroundings of the vehicle are recorded by means of surroundings sensors, and data recorded by the surroundings sensors is amalgamated in an amalgamation module, wherein it is determined from the amalgamated data and, optionally, from data of a digital map and/or satellite-based navigation system, whether a situation deviating from the normal state of the vehicle is present.

In one embodiment, a situation deviating from the normal state of the vehicle is recognized
when a switch-off command has been received by a backend, and/or
when the vehicle is driving significantly more slowly than a current speed limit or than other traffic participants in the surroundings and when there is no traffic jam present, and/or
in the event of a recognized accident, and/or
in the event of recognized police intervention, and/or
when it is recognized that other traffic participants are sounding their horns.

According to one aspect of the present invention, a vehicle, in particular a utility vehicle, is proposed, comprising at least one outer surface, for example a side surface or rear-facing surface, on which information can be depicted or is depicted, wherein a device for covering or switching off the information displayed on the outer surface of the vehicle is provided as described above.

Exemplary embodiments of the invention are explained in more detail below by means of drawings.

### BRIEF DESCRIPTION OF THE DRAWING FIGURES

Here are shown:

FIG. 1: a schematic view of a vehicle having an embodiment of a device for covering or switching off information displayed on an outer surface,

FIG. 2: a schematic view of the vehicle from FIG. 1 in an unsuitable situation,

FIG. 3: a schematic view of the outer surface with a different embodiment of the device for covering or switching off information displayed on the outer surface,

FIG. 4: a schematic view of the outer surface with a further embodiment of the device for covering or switching of information displayed on the outer surface,

FIG. 5: a schematic view of the outer surface from FIG. 4 in an unsuitable situation,

FIG. 6: a schematic view of a processing chain for operating an autonomous vehicle,

FIG. 7: a schematic front view of a tractor unit having a brand logo, and

FIG. 8: a schematic front view of the tractor unit having a neutral surface instead of the brand logo.

Parts corresponding to one another are provided with the same reference numeral in all figures.

### DETAILED DESCRIPTION

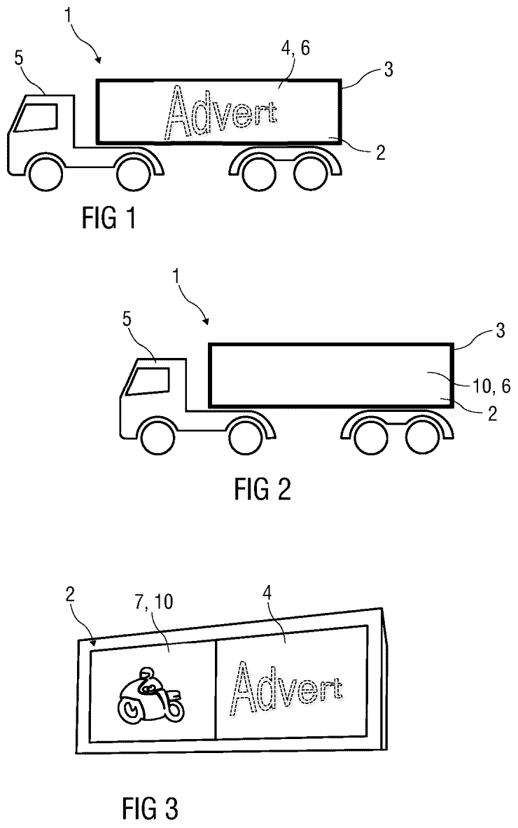

FIG. 1 is a schematic view of a vehicle 1, in particular a utility vehicle 1, comprising a tractor unit 5 and a semi-trailer 3 or trailer. The vehicle 1 has several outer surfaces 2, for example at least one side surface 2 or rear-facing surface of the semi-trailer 3, trailer or a container transported on the tractor unit 5, the semi-trailer 3 or trailer. The outer surface 2 or side surface 2 or rear-facing surface can also be formed by tarpaulin.

Information 4, in particular an advert 4, for example a company logo, is applied to at least one of these outer surfaces 2, in particular those that are easily visible to other traffic participants, for example on the at least one side surface 2.

The present invention discloses a device 10 (depicted in FIG. 2) for covering or switching off information 4 displayed on the outer surface 2, with which it is intended to avoid this information 4 having negative associations. A potentially negative association can emerge or be present in the following situations, for example:
the vehicle 1 constitutes a traffic obstacle due to an unadjusted mode of driving, for example due to driving slowly on the free motorway, in particular significantly more slowly than a current speed limit or than other traffic participants. This can be caused by a driver of the vehicle 1, for example when they are inebriated. Similarly, in the case of an autonomous vehicle 1, this can be caused by a malfunction.
the vehicle 1 has stopped at the side of the road, for example when the vehicle 1 is designed as an autonomous vehicle 1 and aborts its mission as a result of dysfunctional navigation.
the vehicle 1 is stopped by the police.
other traffic participants sounding their horns.

In this case, it is advantageous if other traffic participants do not see with what haulage contractor the conspicuous vehicle 1 is associated.

For a haulage contractor as the operator of autonomous vehicles 1, in particular utility vehicles 1, it is exceptionally desirable that their clients whose information 4 is applied to the vehicles 1 are not embarrassed by the driving behavior of the utility vehicle 1 that is associated with their logo, and their logo does not appear in conjunction with negative headlines in the press. Otherwise, these clients could decide not to have their goods transported by this haulage contractor in future.

It is thus desirable to depict the information 4 on the outer surface 2 in suitable situations (also referred to as the normal state) and to hide it in unsuitable situations (also referred to as a situation deviating from the normal state).

In the interests of the haulage contractor, the information 4 should thus be visible in suitable situations and not visible in unsuitable situations.

The following therefore considers, on the one hand, how it can be detected while driving that the vehicle 1 is in an unsuitable situation, and, on the other hand, solutions are suggested as to how the information 4 can be hidden as quickly as possible.

In an embodiment of the invention, a membrane 6 is applied over the outer surface 2 provided with the information 4, the membrane being transparent in a base state, for example, and becoming untransparent by applying a voltage. FIG. 2 is a schematic view of the vehicle 1 with the membrane 6 set to untransparent.

By applying a voltage, the membrane 6 becomes opaque and thus hides the information 4, whereby it cannot be recognized with which client the load is associated. In order to avoid attention, it can be provided to switch the membrane 6 from transparent to untransparent unabruptly, but to gradually carry out the switch over a certain period of time (fading).

FIG. 3 is a schematic view of the outer surface 2 with a different embodiment of the solution according to the invention. In this case, a display unit 7, for example an electronic display, is arranged on the outer surface 2, on which display unit the information 4 can be depicted. In an unsuitable situation, the information 4 on the display unit 7 is faded out or the display unit 7 is switched off.

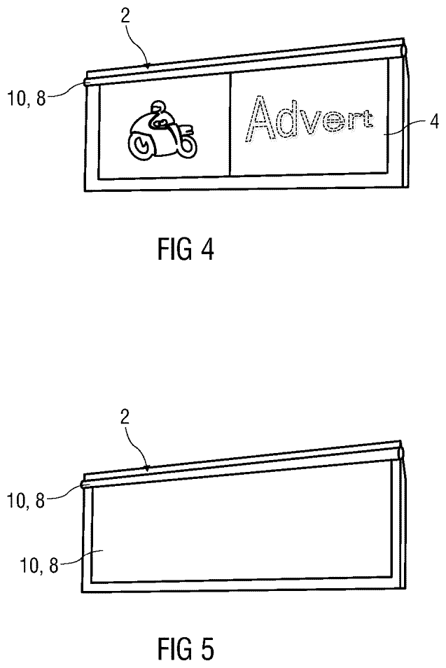

FIG. 4 is a schematic view of the outer surface 2 with a further embodiment of the solution according to the invention. In this case, a roller blind 8 is attached on the outer surface 2, on which the information 4 is depicted. In an unsuitable situation, the roller blind 8 is pulled over the outer surface 2 with the information 4 in order to hide it. This is depicted schematically in FIG. 5. In a suitable situation, the roller blind 8 is or remains rolled up and reveals the view of the information 4.

If an unsuitable situation ends then the covering or switching off of the information 4 can be reversed.

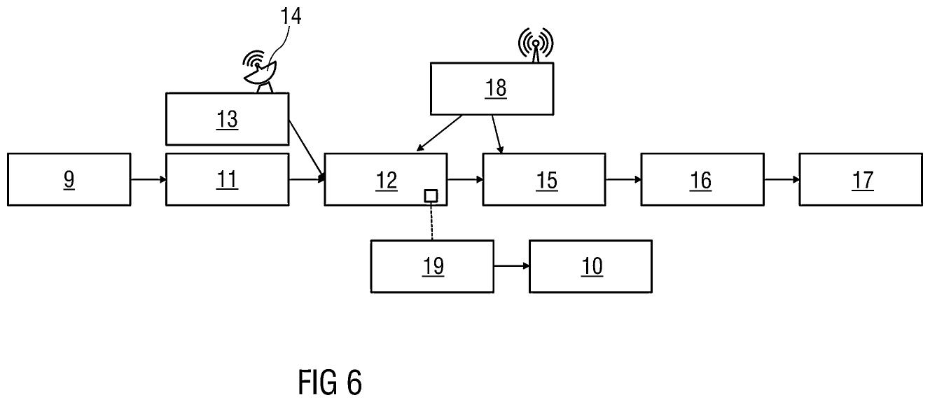

FIG. 6 is a schematic view of a processing chain for operating an autonomous vehicle 1.

A surroundings of the vehicle 1 is detected by means of surroundings sensors 9, and the data detected by these is amalgamated in an amalgamation module 11. In a situation analysis module 12, a current situation of the vehicle 1 is analyzed from the amalgamated data and from the data of a digital map 13 and a satellite-supported navigation system 14. On one hand, this provides a movement planning module 15, which controls a movement regulation module 16 for controlling and/or regulating actuator technology 17 of the vehicle 1 in order to control and/or to regulate its movement in the longitudinal and transverse direction. On the other hand, the situation analysis module 12 determines whether the current situation is a suitable situation or an unsuitable situation in the sense of the present invention.

The situation analysis module 12 and the movement planning module 15 can furthermore communicate wirelessly with a backend via a communication module 18.

In a control module 19 for controlling the covering or switching off of the information 4 depicted on the at least one outer surface 2, which control module can be part of the situation analysis module 12, the device 10 for covering or switching off information 4 displayed on the outer surface 2 is actuated when an unsuitable situation exists.

An unsuitable situation can be recognized, for example, when a switch-off command has been received by the backend when the vehicle 1 is driving clearly more slowly than a current speed limit or than other traffic participants and there is no traffic jam present, in the event of a recognized accident or recognized police intervention, when it is recognized that other traffic participants are sounding their horns or in further cases not listed here. In these cases, the device 10 is controlled in such a way that the information 4 is covered or switched off. If none of these cases is present and thus a suitable situation exists, then the device 10 is controlled in such a way that the information 4 remains or becomes visible.

The present invention also applies when the outer surface 2 with the information 4 is part of the tractor unit 5. For example, it can be provided to hide information 4 formed as a brand logo 4 on the tractor unit 5 in an unsuitable situation.

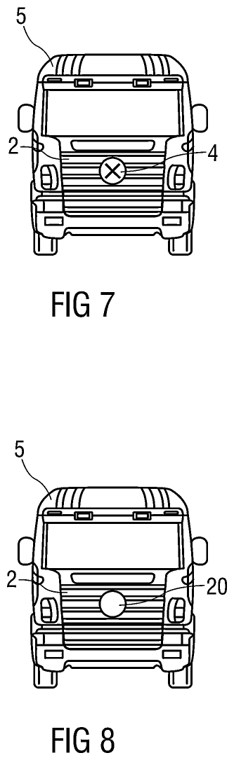

FIG. 7 is a schematic front view of a tractor unit 5 with a brand logo 4. In an unsuitable situation, it can be provided that the brand logo 4 is folded down and its rear side with a neutral surface 20 becomes visible.

FIG. 8 is a schematic front view of the tractor unit 5 with the neutral surface 20.

Although the invention has been illustrated and described in detail by way of preferred embodiments, the invention is not limited by the examples disclosed, and other variations can be derived from these by the person skilled in the art without leaving the scope of the invention. It is therefore clear that there is a plurality of possible variations. It is also clear that embodiments stated by way of example are only really examples that are not to be seen as limiting the scope, application possibilities or configuration of the invention in any way. In fact, the preceding description and the description of the figures enable the person skilled in the art to implement the exemplary embodiments in concrete manner, wherein, with the knowledge of the disclosed inventive concept, the person skilled in the art is able to undertake various changes, for example, with regard to the functioning or arrangement of individual elements stated in an exemplary embodiment without leaving the scope of the invention, which is defined by the claims and their legal equivalents, such as further explanations in the description.

### LIST OF REFERENCE NUMERALS

1 Vehicle, utility vehicle
2 Outer surface, side surface
3 Trailer
4 Information, advert, brand logo
5 Tractor unit
6 Membrane
7 Display unit
8 Roller blind
9 Surroundings sensors
10 Device
11 Amalgamation module
12 Situation analysis module
13 Digital map
14 Satellite supported navigation system
15 Movement planning module
16 Movement regulating module
17 Actuator technology
18 Communication module
19 Control module
20 Neutral surface

What is claimed is:

1. A device configured to cover or switch off information displayed on an outer surface of a vehicle responsive to determining that a present situation of the vehicle deviates from a normal state.

2. The device of claim 1, wherein a membrane is arranged over the outer surface provided with the information, wherein the membrane is transparent in the normal state and is configured to become untransparent by applying a voltage.

3. The device of claim 2, wherein the membrane is configured to gradually become untransparent by applying a voltage.

4. The device of claim 1, wherein the vehicle includes an electronic display unit on which the information is depictable, wherein the device is configured to fade out the depiction of the information on the electronic display unit or to switch off the electronic display unit when the present situation deviates from the normal state.

5. The device of claim 1, wherein the vehicle includes a roller blind, wherein the device is configured to pull the roller blind over the outer surface with the information when the present situation deviates from the normal state.

6. The device of claim 1, wherein the information displayed on the outer surface is a brand logo, wherein the device is configured to fold down the brand logo in a situation deviating from the normal state and to make a rear side of the vehicle with a neutral surface visible.

7. A method for operating a device for covering or switching off information displayed on an outer surface of a vehicle, the method comprising:
determining that a present situation of the vehicle deviates from a normal state; and
covering or switching off, responsive to determining that the present situation deviates from the normal state, the information displayed on the outer surface.

8. The method of claim 7, further comprising:
detecting, using surroundings sensors of the vehicle, surroundings of the vehicle;
amalgamating data detected using the surroundings sensors,
wherein the determination that the present situation deviates from the normal state is based at least on the amalgamated data.

9. The method of claim 7, wherein it is determined that the present situation of the vehicle deviates from the normal state based on:
receipt of a switch-off command by a backend,
the vehicle driving significantly more slowly than a current speed limit or than other traffic participants in the surroundings and when there is no traffic jam present,
an accident is recognized,
police intervention is recognized, or
other traffic participants are sounding their horns.

10. A vehicle comprising:
at least one outer surface on which information is displayed; and
a device configured to cover or switch off the information displayed on the at least one outer surface responsive to determining that a present situation of the vehicle deviates from a normal state.
